(19) United States
(12) Patent Application Publication
(10) Pub. No.: US 2008/0212422 A1
(43) Pub. Date: Sep. 4, 2008

(54) Method and Apparatus For Recording Information on a Multi-Layered Optical Disc

(75) Inventors: Robert Albertus Brondijk, Eindhoven (NL); Petrus Jacobus Hubertus Johannes Van Asten, Eindhoven (NL); Wiebe De Haan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/916,824

(22) PCT Filed: May 31, 2006
(86) PCT No.: PCT/IB2006/051727

§ 371 Date: Dec. 7, 2007

(30) Foreign Application Priority Data
Jun. 9, 2005 (EP) 05300472.7

(51) Int. Cl. G11B 27/034

(52) U.S. Cl. 369/47.13

(57) ABSTRACT

A method for copying information from a multi-layered optical source disc (2S) to on a multi-layered optical target disc (2T) is described. A first portion (67) of the source data is located in a first source storage space (LsO), and a second portion (68) of the source data is located in a second source storage space (LsI). The first source data portion has a logical end address (M) smaller than the physical end address (Nt) of the first target storage space (LtO). All source cells from the first source storage space are recorded into a first target data portion (77) of the first target storage space. The remainder portion (74) of the first target storage space is defined as a dummy data portion. Then, the cells from the second source data portion (68) are recorded into a second target data portion (78) of the second target storage space (LtI).

### FIELD OF THE INVENTION

The present invention relates in general to a method for writing information on a multiple-layer optical storage disc, and to a device for executing the method.

### BACKGROUND OF THE INVENTION

As is commonly known, an optical storage disc comprises at least one track, either in the form of a continuous spiral or in the form of multiple concentric circles, of storage space where information may be stored in the form of a data pattern. Optical discs are very successful, and several different types have been developed. One such type is DVD (Digital Versatile Disc), and the present invention relates particularly to DVD discs. However, the gist of the present invention is also applicable to other types of discs; therefore, the following description is not to be understood as limiting the scope of the present invention to DVD discs only.

Optical discs may be read-only type, containing information which can only be read by a user. The optical storage disc may also be a writeable type, where information may be stored by a user. Such discs may be a write-once type, indicated as writable (R), but there are also storage discs where information can be written many times, indicated as rewritable (RW). In the case of DVD, a distinction is made between two formats, i.e. the “minus”-format (DVD-R, DVD-RW) and the “plus”-format (DVD+R, DVD+RW).

For writing information in the storage space of the optical storage disc, a storage track is scanned by an optical write beam, typically a laser beam, of which the intensity is modulated to cause material changes which can later be read out by scanning the storage track by an optical read beam. Since the technology of optical discs in general, and the way in which information can be stored in an optical disc, is commonly known, it is not necessary here to describe this technology in more detail. However, it is noted that a storage track defines a range of storage locations having unique addresses.

Typically, an optical storage system comprises an optical disc as a record medium, and further comprises a disc drive apparatus and a host apparatus. The disc drive apparatus is a device, comprising optical means for actually writing data, capable of accessing all storage blocks where it is physically possible to store information. The unique addresses of all these physical storage locations are indicated as physical addresses. The host apparatus, which may be a PC running a suitable program, or an application of a consumer apparatus such as a video recorder, is a device which communicates with the disc drive, and sends commands to the disc drive instructing the disc drive to write certain data to a certain storage location. In contrast to the disc drive apparatus, the host apparatus only has access to a part of the physical storage space, this part being indicated as logical storage space, and the storage blocks in the logical storage space also have logical storage addresses. Although the logical storage space does not need to be a physically contiguous storage space, the storage blocks in the logical storage space have consecutive logical addresses, which are usually not identical to the physical addresses.

Conventionally, an optical disc has only one storage layer containing a storage track. More recently, optical discs have been developed having two or even more storage layers, each storage layer containing a storage track in the shape of a spiral or multiple concentric circles. In such case, the logical storage space extends over multiple storage layers, hence the range of logical addresses extends contiguously over multiple storage layers. The transition from the last block of one storage layer to the first block of the next storage layer is such that the logical address is incremented only by 1.

The present invention relates particularly to optical discs having two storage layers. However, the gist of the present invention is also applicable to discs having three or more layers; therefore, the following description is not to be understood as limiting the scope of the present invention to double-layered discs only.

It is noted that the present invention relates to optical discs where at least two storage layers are approached by a laser beam from the same side. The disc has a main surface which is directed towards the laser; this main surface will be indicated as entrance surface. For access to a specific storage layer, the laser beam enters the disc at the entrance surface, and travels the depth of the disc until it reaches the specific storage layer. Selection of a specific storage layer involves focussing the laser beam at the corresponding depth. In the following, the storage layer which is located closest to the entrance surface will be indicated as first storage layer, and the corresponding logical space will be indicated as L0; the next storage layer will be indicated as second storage layer, and the corresponding logical space will be indicated as L1. Thus, in the case of a dual layer disc, the entire logical space of the disc will be L0+L1.

In the case of a dual layer disc, the first layer L0 extends from an inner radius to an outer radius. In other words, logical address zero corresponds to a certain physical address (30000) relatively close to the centre of the disc, while increasing logical addresses correspond to increasing track radius, such that the highest logical address corresponds to a radius relatively close to the perimeter of the disc.

For the second layer L1, there are two possibilities. In one possibility, the logical addresses are numbered in the same way as L0, i.e. increasing from the inner track radius to the outer track radius; this arrangement is indicated as Parallel Track Path (PTP). In another possibility, indicated as Opposite Track Path (OTP), the logical addresses are numbered from the outer track radius to the inner track radius.

When a disc is written according to the PTP arrangement, the laser beam scans L0 in a direction from centre to perimeter. After a jump to L1, writing continues at the innermost track of L1, in the same direction from centre to perimeter. In such case, the storage capacity of L1 is independent from the location of the last block of the first track. In an OTP case, however, after a jump from L0 to L1, writing continues at the location of the jump, in the opposite direction from perimeter to centre; in such case, the size of the available logical space in L1 is clearly dependent on the location of the last block of the first track.

The present invention relates specifically to a disc of OTP type, i.e. a disc having at least one pair of successive storage layers with mutually opposite track direction. However, the gist of the present invention is also applicable to a disc of PTP type.

A typical problem occurs in case the information being written is video information which is copied from a source medium, for instance a hard-disk or an optical disk, such that the total amount of video data is larger than the capacity of the first storage space. A specific problem occurs when the source medium is a DVD+RW disc having a first storage space L0 smaller than the standard size; this situation can occur because in the case of writing information to a DVD+RW disc it is possible to set the size of first storage space L0 to a value smaller than standard.

During writing, the host organizes DVD Video data in cells, and a transition from one layer to the next is only allowed at a cell boundary; this is related to the fact that, on reading video data from disc, it is desirable to have seamless continuation of video image display. On the other hand, the disc drive continues writing in L0 until a predefined logical end address is reached; after having written information at the end address, the disc drive jumps to L1 and continues writing at the next logical address in L1 (at the inner radius in a PTP case, or at the radius of the end address of L0 in an OTP case). Usually, this transition from L0 to L1 does not correspond to a video cell boundary. As a result, on playing the recording, display is not seamless: display may show a delay, a freeze-image, or a “hick-up”, or the disc drive may even crash.

The disc drive, receiving the video data from the host, has no means for generating cell boundaries when approaching the end of L0 (in fact, the disc drive does normally not even “know” that it is writing video information). On the other hand, the host device is not capable of instructing the disc drive to use a specific physical address, and is not capable of instructing the disc drive to make a transition to L1 before having reached the end of L0 (a transition to L1 can only be made at the end of L0).

It may be that the video data from the source medium is already organized in cells; in that case, it is highly likely that the cell boundaries of the source video data are not aligned with the end of the first storage space L0. It may also be that the video data from the source medium is not organized in cells at all.

An important objective of the present invention is to overcome the above difficulties.

More specifically, an objective of the present invention is to assure that the last logical address of a storage layer does not fall inside a video cell.

A particular objective of the present invention is to support seamless image reproduction on reading.

Another particular objective of the present invention is to improve trickplay.

In the above, objectives of the present invention have been explained in the context of video cell boundaries in the case of writing video data. However, it may be desirable for other reasons to organize data in cells, and to have a transition from L0 to L1 correspond to a data cell boundary.

### SUMMARY OF THE INVENTION

According to an important aspect of the present invention, a host is capable of comparing the amount of video data from the source medium with the storage capacity of the target disc. If the video amount is larger than the (remaining) space in the first logical space L0 but smaller than the total of first logical space L0 and second logical space L1 combined, the host stops writing the video data after having completed a video cell at some distance from the end of the first logical space L0. Then, the remaining space until the end of the first logical space L0 is filled with dummy data, and the host make a transition to the second logical space L1. Depending on design considerations, the host starts writing in the first available storage location of the second logical space L1, or the host may start writing in the second logical space L1 at a location aligned with the end of the last video cell in the first logical space L0, or the host may start writing in the second logical space L1 at a location chosen such that the end boundary of the last cell in the second logical space L1 is aligned with the first cell in the first logical space L0.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1 is a block diagram schematically illustrating a data storage system;

FIG. 2 is schematical cross-section of a dual-layer optical disc;

FIG. 3 is a diagram schematically depicting a double-track storage space of a storage medium in an OTP case;

FIG. 4 is a diagram schematically illustrating a prior art recording process;

FIG. 5A is a diagram schematically illustrating a recording in a source disc;

FIGS. 5B-C are diagrams schematically illustrating steps in a recording process according to the present invention;

FIGS. 6A-C are diagrams schematically illustrating steps in a recording process according to the present invention;

FIGS. 7A-D are diagrams schematically illustrating steps in a recording process according to the present invention;

FIGS. 8A-D are diagrams schematically illustrating steps in a recording process according to the present invention;

FIGS. 9A-E are flow diagrams schematically illustrating examples of a recording process according to the present invention.

### DETAILED DESCRIPTION OF THE INVENTION

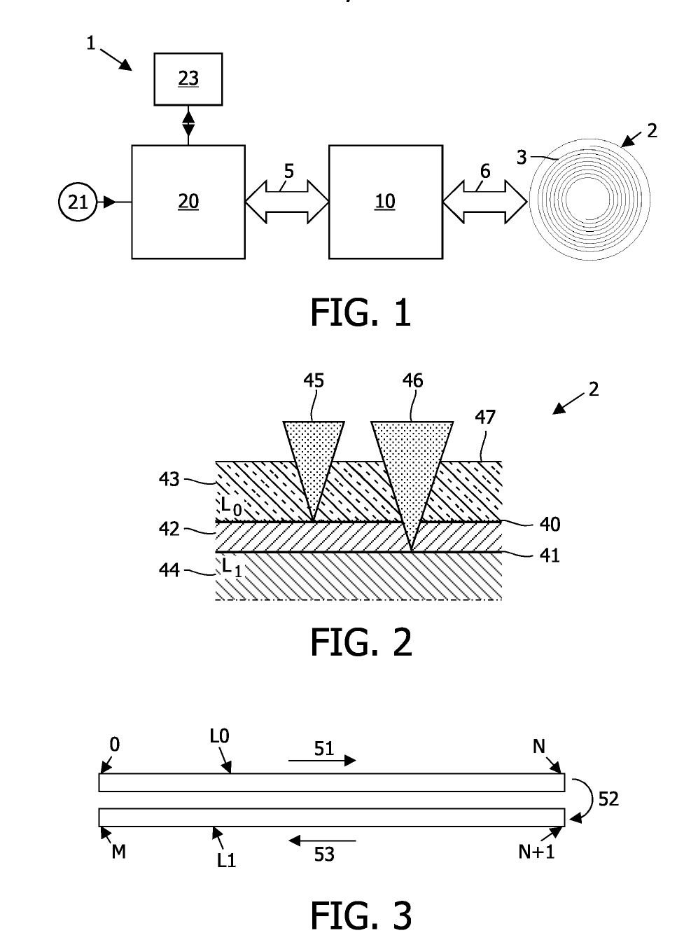

FIG. 1 is a block diagram schematically illustrating a data storage system 1, comprising an optical disc 2, a disc drive device 10, and a host device 20. In a typical practical implementation, the host device 20 may be a suitably programmed personal computer (PC); it is also possible that the data storage system 1 is implemented as a dedicated user apparatus such as a video recorder, in which case the host device 20 is the application part of such apparatus. In a specific embodiment, the optical disc 2 is a DVD, more specifically a DVD-R.

A host/drive communication link between host device 20 and disc drive 10 is indicated at 5. Likewise, a drive/disc communication link between disc drive 10 and disc 2 is indicated at 6. The drive/disc communication link 6 represents the physical (optical) read/write operation as well as the physical addressing of the disc 2. The host/drive communication link 5 represents a data transfer path as well as a command transfer path.

It is noted that disc drives are known, and that the present invention can be implemented using an existing disc drive; therefore, it is not necessary here to describe the design and operation of the disc drive 10 in great detail.

The optical disc 2 has a storage space 3, which has the form of two or more continuous spiral-shaped tracks or tracks in the form of multiple concentric circles, where information can be stored in the form of a data pattern. Since this technology is commonly known to persons skilled in the art, this technology will not be explained in further detail.

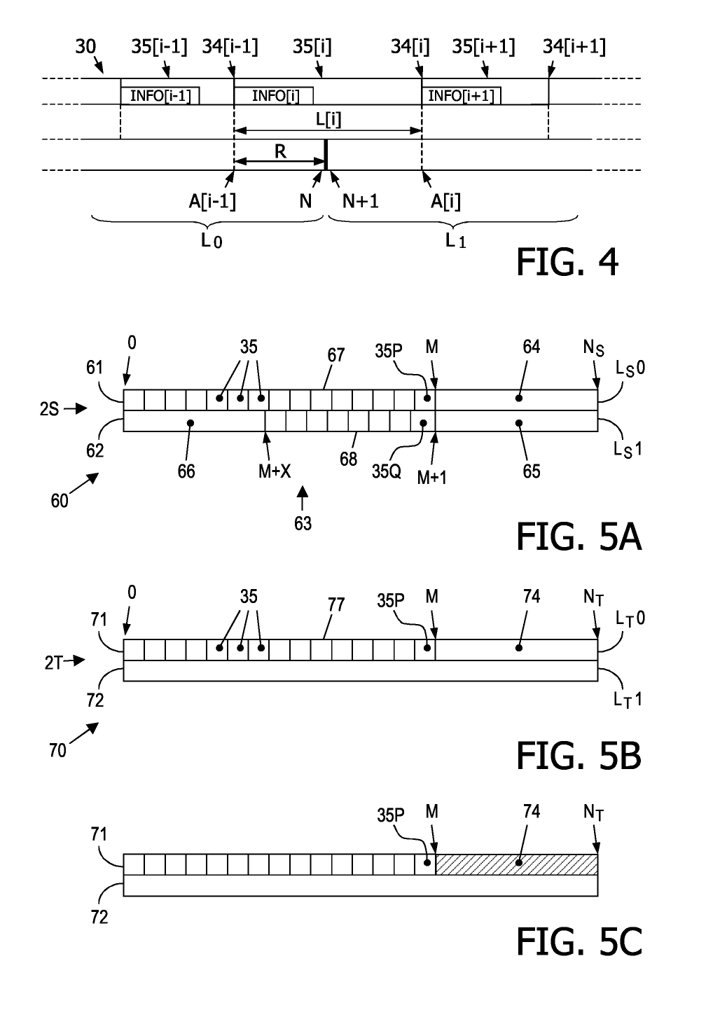

The several tracks of the storage space 3 are located in different storage layers of the optical disc 2. FIG. 2 is a schematic cross-section of a portion of the disc 2, showing a first storage layer 40 and a second storage layer 41. Between these two storage layers is a transparent spacer layer 42. An optical beam is illustrated in two conditions, i.e. focussed on the first layer 40 (beam 45) and focussed on the second layer 41 (beam 46). The disc 2 has an entrance surface 47, where the optical beam 45, 46 enters a transparent cover layer 43. The first storage layer 40 is closer to the entrance surface 47 than the second storage layer 41. Reference numeral 44 indicates a substrate of the disc 2.

It is noted that in FIG. 2 the entrance surface 47 is the top surface; depending on the configuration of the disc drive, the entrance surface may also be the lower surface.

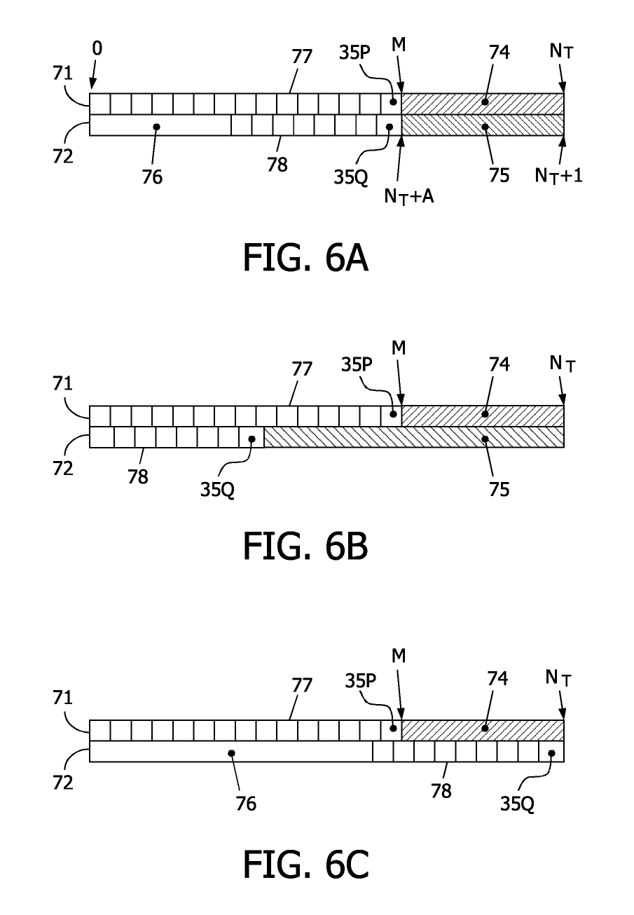

The storage locations in the storage layers 40 and 41 have logical addresses; these logical addresses define a logical space. The logical space of the first storage layer 40 is indicated L0, while the logical space of the second storage layer 41 is indicated L1. FIG. 3 is a diagram schematically showing these two logical spaces L0 and L1 as longitudinal strips. First logical space L0 extends from logical address 0 to logical end address N, thus has a capacity of N+1 addresses. The next logical address N+1 is to be found in the second logical space L1, approximately aligned with address N, approximately aligned with address N in the case of an OTP disc. The second logical space L1 extends to logical end address M; if the size of the second logical space L1 is equal to the size of the first logical space L0, M=2N+1.

In the first logical space L0, logical address 0 is located closer to the centre of the disc 2, and logical end address N is located closer to the perimeter of the disc 2. In the second logical space L1, in the case of an OTP disc, the first logical address N+1 is located closer to the perimeter of the disc 2, substantially aligned with logical end address N of L0, and the logical end address M is located closer to the centre of the disc 2. When information is recorded, the disc drive starts at logical address 0, following the first logical space L0 from the centre to the perimeter, as indicated by arrow 51. After writing in the end address N, a transition is made to the second logical space L1, as indicated by arrow 52, and then the second logical space L1 is followed from the perimeter to the centre, as indicated by arrow 53.

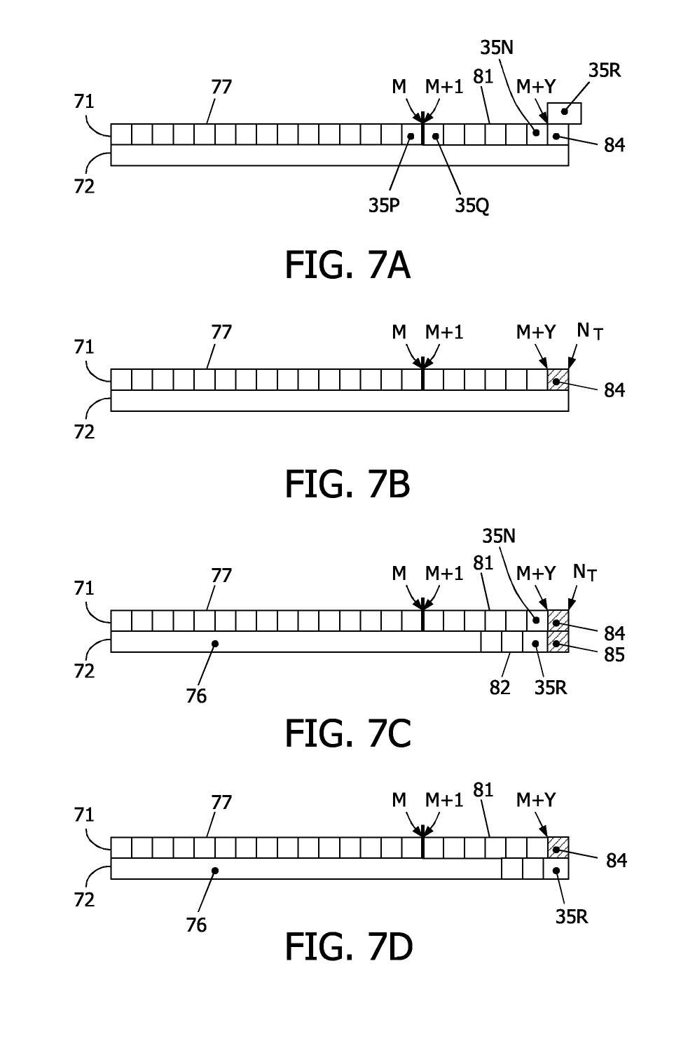

FIG. 4 is a diagram comparable to FIG. 3, showing the transition of the two storage spaces L0 and L1 at a larger scale than FIG. 3, and also showing schematically a video sequence 30, for instance corresponding to a movie, also illustrated as a strip. As a difference with respect to FIG. 3, the two storage spaces L0 and L1 are depicted next to each other, the start of L1 (address N+1) adjacent to the end of L0 (address N). For sake of convenience, the start of L0 and the end of L1 are not shown.

The host 20 receives the video from a video storage medium 21 (FIG. 1), which may for instance be a hard-disc or an optical disc. The host 20 organizes the video data to form cells 35; cell boundaries between the video cells 35 are indicated at 34. Specifically, a cell boundary is the boundary between the last address of the previous cell and the first address of the next cell. With respect to “video cells”, reference is made to part III of the DVD video specification.

In the following, individual cells are distinguished by adding an index between square brackets. Likewise, individual cell boundaries are distinguished by adding an index between square brackets. The index x of a cell boundary 34[x] corresponds to the index of the cell 35[x] immediately before that cell boundary 34[x]. Further, each cell 35[x] has a length L[x]. Normally, the cells will have equal lengths, but this is not essential; by way of illustrative example, the following will assume that all lengths are equal to a standard length Ls. As will be known to persons skilled in the art, each cell 35[x] contains information (in NAVPACKS) indicating the length L[x] of that cell as well as a pointer to the logical address A[x] of the end of that cell; this information is schematically indicated in FIG. 4 as INFO[x].

Assume that a data storage system not implemented in accordance to the present invention is to store the video sequence 30. The host device 20 transfers the video sequence 30 to the disc drive 10 over host/drive communication link 5, and the disc drive 10 writes the video sequence 30 to disc 2 over drive/disc communication link 6, wherein the start of the video sequence 30 is written at a block in L0 having a certain logical address which may be determined by the host device 20, or which may be the first available block after a previous recording. As writing continues, the logical addresses increase. FIG. 4 illustrates the write process approaching the end of the first storage space L0. The host 20 has written a complete previous video cell 35[i−1] having end address A[i−1]. The remaining space R in the first storage space L0 is smaller than the standard cell length Ls, so the next video cell 35[i] will extend from address A[i−1]+1 to cell end address A[i]=A[i−1]+Ls which is located in the second storage space L1. If address N is reached, the disc drive 10 makes a transition to the first available block in the next storage layer L1, having logical address N+1. It can be seen in FIG. 4 that this transition corresponds to a location somewhere within the video cell 35[i], which is undesirable.

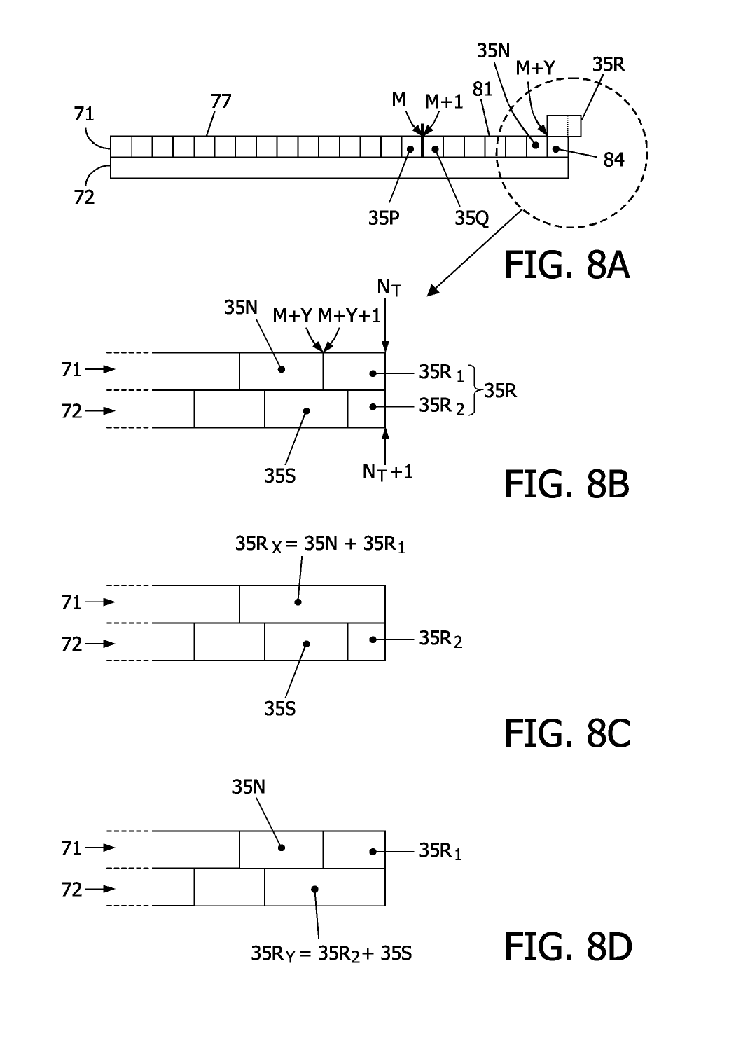

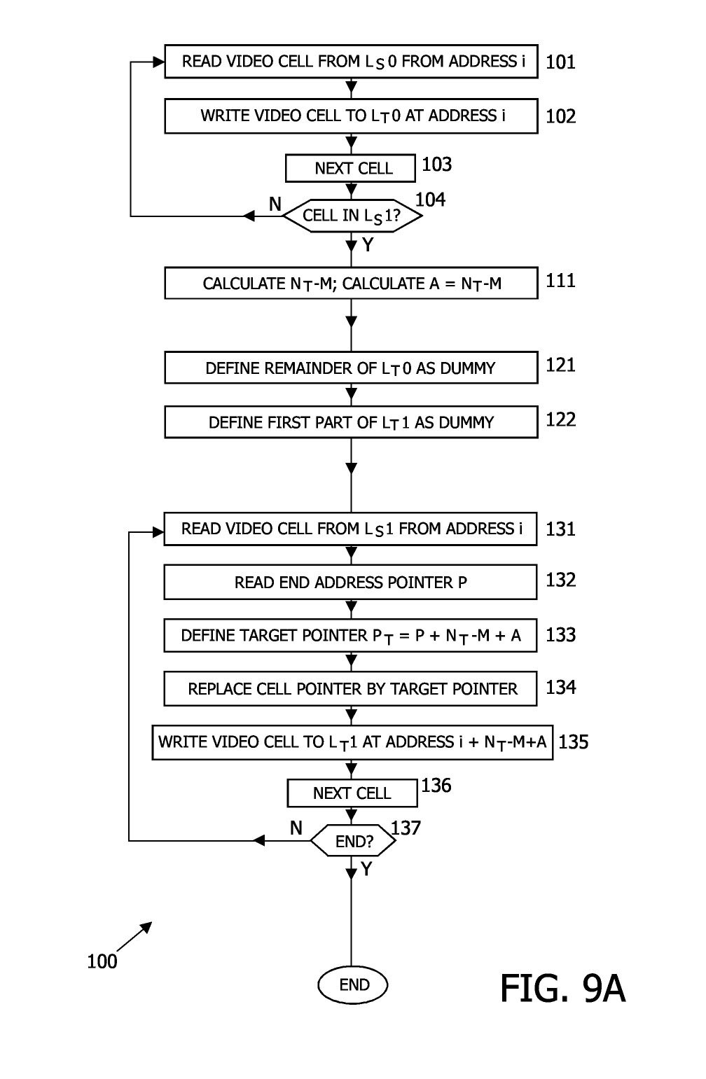

In the following, the invention will be explained for the exemplary case that the contents of a dual-layer DVD+RW disc, which will be indicated as source disc 2S, is to be copied to a dual-layer DVD-RW disc, which will be indicated as target disc 2T. FIG. 5A schematically illustrates the storage space 60 (also indicated as source storage space) of the source DVD+RW disc 2S, comprising first source storage space 61 (also indicated as Ls0) and second source storage space 62 (also indicated as Ls1). It is assumed that the first source storage space 61 has a capacity of Ns+1 physical addresses (from 0 to Ns), and that the second source storage space 62 also has a capacity of Ns+1 physical addresses (from Ns+1 to 2Ns+1).

It is further assumed that the source disc 2S contains a video recording 63 that is distributed over both source storage spaces but does not fill the entire capacity of the source disc 2S. When the recording was made, the first source storage space 61 was filled up to a certain logical end address M (M<Ns), and then a transition was made to the second source storage space 62, where writing continued, in opposite direction, from logical address M+1 onwards, till recording end logical address M+X. For sake of convenience, it is assumed that the recording 63 has started at logical address 0. The data is organized in cells 35, as illustrated in FIG. 5A; the transition from logical address M to logical address M+1 corresponds to a cell boundary. The last cell in the first source storage space 61 (ending at logical address M) is indicated by reference numeral 35P, and the first cell in the second source storage space 62 (starting from logical address M+1) is indicated by reference numeral 35Q.

Thus, the source data 63 comprises a first source data portion 67 having a first logical end address M, and a second source data portion 68 having a second logical start address M+1 and a second logical end address M+X. The physical location of the first logical end address M is substantially aligned with the physical location of the second logical start address M+1.

The portion of the first source storage space 61 beyond physical address M (from physical address M+1 to physical address Ns) has remained empty; this storage space portion, which will be indicated as first remainder storage portion 64, involves Ns-M addresses. The same applies to the portion of the second storage space 62 which lies between the beginning of the second storage space 62 and the beginning of the recording 63 (i.e. from physical address Ns+1 to logical address M+1), which portion will be indicated as second remainder storage portion 65. The second remainder storage portion 65 contains physical addresses N+1 up to and including Ns+(Ns−M), and logical address M+1 corresponds to physical address Ns+(Ns−M)+1. Finally, there is a third remainder storage portion 66 beyond logical address M+X (containing the physical addresses Ns+(Ns−M)+X+1 up to and including 2Ns+1.

At first sight, the logical thing to do is to make a direct copy from the source disc 2S to the target disc 2T. However, this would mean that the target disc 2T would also have empty remainder storage portions, which is not possible for a DVD-RW disc. The invention proposes several solutions, as will be explained in the following.

FIG. 5B is a schematic view comparable to FIG. 5A, illustrating the storage space 70 (also indicated as target storage space) of the target disc 2T, comprising first target storage space 71 (also indicated as Lt0) and second target storage space 72 (also indicated as Lt1). It is assumed that the first target storage space 71 has a capacity of Nt+1 physical addresses (from 0 to Nt), and that the second target storage space 72 also has a capacity of Nt+1 physical addresses (from Nt+1 to 2Nt+1). It is further assumed that Nt≧Ns applies, although this is not critical.

FIG. 5B illustrates a first phase of the recording method according to the present invention. The host 20 reads all cells of the first source data portion 67, and sends these cells to the disc drive 10, which records these cells up to logical address M. Assuming that recording starts at physical address 0 and that the target disc 2T does not have defective storage locations, the first target storage space 71 of the target disc 2T then contains a first target data portion 77, copy of the first source data portion 67, extending to physical address M. The portion of the first target storage space 71 beyond this address, i.e. from physical address M+1 to physical address Nt, will be indicated as first remainder portion 74.

It is noted that the recording in practice may start at a physical address differing from zero, and some defective storage locations may be encountered, but the consequential renumbering of the target data addresses will be clear to a person skilled in the art and will not be specified here for sake of convenience.

It is further noted that, when writing the video data into the target disc 2T, the cell structure of the video data of the recording 63 in the source disc 2S is maintained. Thus, individual cells are indicated by the same reference numeral 35.

FIG. 5C is a schematic view comparable to FIG. 5B, illustrating a second phase of the recording method according to the present invention. The host 20 sends information to the disc drive 10, defining this first remainder portion 74 of the target disc 2T as a dummy data portion, indicated by the hatching in FIG. 5C. For instance, after having written the video data in the physical address M, the host continues sending dummy data to the disc drive 10, which will write these dummy data into the first target storage space 71 from physical address M+1 to physical address Nt, filling these addresses with any dummy data.

It is noted that the dummy data in the first remainder portion 74 can be any data, for instance zero data.

It is further noted that it is not actually necessary to write dummy data in all addresses of the first remainder portion 74. It is sufficient if the dummy data is written in the first sector of the first remainder portion 74, and that the NAVPACK of this first sector contains the length (Nt−M) of the first remainder portion 74, contains the end address (Nt) of the first remainder portion 74, and contains a code indicating that this video cell only contains dummy data (dummy code).

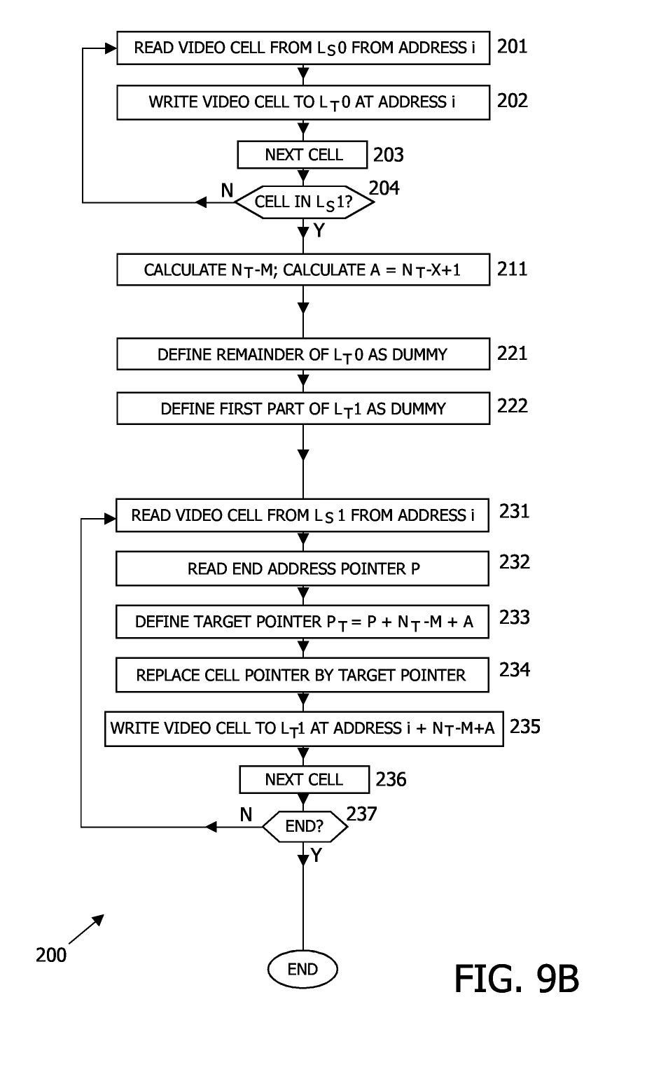

Now that the host 20 has entirely written the first target storage space 71, a transition can be made to the second target storage space 72, and the second source data portion 68 of the source disc 2S can be copied. The present invention provides three different variations, which will be explained with reference to FIGS. 6A-C.

In a first variation, illustrated in FIG. 6A, the structure of the recording 63 is maintained. Similarly as described above with reference to FIG. 5C, the host 20 sends information to the disc drive 10, defining an initial portion 75 of the second target storage space 72 as a dummy data portion, indicated by the hatching in FIG. 6A. This portion, which will also be indicated as second remainder portion 75 or second dummy data portion 75, extends from physical address Nt+1 up to and including physical address Nt+A, wherein A defines the size of the second dummy data portion 75.

The physical end address Nt+A of the second remainder portion 75 is chosen such that the physical size (radial dimension measured on the target disc 2T) of the second remainder portion 75 substantially corresponds to the physical size of the first remainder portion 74. To this end, A is substantially equal to Nt−M.

It is noted that, with respect to the dummy data in the second dummy data portion 75, the same applies as what has been said above with respect to the dummy data in the first remainder portion 74.

It is further noted that the dummy data in first remainder portion 74 may be written as one video cell. Also, the dummy data in the second remainder portion 75 may be written as one video cell. However, it is also possible that these two remainder portions 74 and 75 are written as one combined video cell, because it is not necessary that the cell boundary of the dummy data corresponds to the outer perimeter of the logical storage space.

After having defined the second remainder portion 75, the host 20 continues with reading the data of the second source data portion 68 of the source disc 2S, and sends this data to the disc drive 10, which will write this data into the second target storage space 72, starting at the first address available after the second remainder portion 75, i.e. starting at physical address Nt+A+1. This phase of the recording process according to the present invention is also illustrated in FIG. 6A. When this phase has been completed, the second target storage space 72 of the target disc 2T contains a second target data portion 78, copy of the second source data portion 68, extending from physical address Nt+A+1 to physical address Nt+A+X. The portion of the second target storage space 72 beyond this address, i.e. from physical address Nt+A+X+1 to physical address 2Nt+1, will be indicated as third remainder portion 76.

As will be known to persons skilled in this art, each video cell contains information pointing towards the logical end address of that specific video cell. It is noted that in the target disc 2T, in view of the fact that the remainder portions 74 and 75 are not empty, the logical addresses correspond to the physical addresses. Thus, before sending the video cells of the second source data portion 68 of the source disc 2S to the disc drive 10, the host 20 updates the information in the NAVPACKS; specifically, indications pointing to addresses i are replaced by indications to addresses i+2(Nt−M).

When the recording procedure has been completed, the target disc 2T comprises a copy recording 73 having the same configuration as the source recording 63 of the source disc 2S, in the sense that the end of cell 35P in the first target storage space 71 is aligned with the beginning of cell 35Q in the second target storage space 72. When the copy recording 73 is played, the transition from cell 35P to the next cell 35Q involves a transition from first target storage space 71 to second target storage space 72 without the need for a radial jump, so seamless playback can be assured. A difference between the target disc 2T and the source disc 2S is to be seen in the value of the logical addresses, as mentioned above. Further, in stead of an empty first remainder storage portion 64 and empty second remainder storage portion 65, the target disc 2T has first and second dummy data storage portions 74 and 75 in the first and second target storage spaces 71 and 72, respectively.

FIG. 6B is a diagram similar to FIG. 6A, illustrating another variation proposed by the present invention. When comparing the diagram of FIG. 6B with the diagram of FIG. 6A, the basic difference is to be seen in the size of the second dummy data portion 75 at the beginning of the second target storage space 72 of the target disc 2T, i.e. the value of A. In the diagram of FIG. 6A, the size A of the second dummy data portion 75 was chosen such that the start of the second target data portion 78 (logical address M+1+2(Nt−M)) is substantially aligned with the end of the first target data portion 77 (address M). In the embodiment illustrated in FIG. 6B, the size A of the second dummy data portion 75 is chosen such that the end of the second target data portion 78 (logical address M+X+(Nt−M)+A) is substantially aligned with the beginning of the first target data portion 77 (address 0). It can easily be seen that A=Nt−X+1 in this case, at least approximately. This means that the second target data portion 78 ranges from logical address Nt+1+(Nt−X+1) to logical address Nt+X+(Nt−X+1).

An advantage of the embodiment illustrated in FIG. 6A is that, on reading the recording 73, the system may show a faster response at the transition from the first storage space Lt0 to the second storage space Lt1. An advantage of the embodiment illustrated in FIG. 6B is that, on reading the recording 73, the system may show improved trick play.

FIG. 6C is a diagram similar to FIG. 6A, illustrating another variation proposed by the present invention, which has an advantage of improved efficiency in the use of storage space. When comparing the diagram of FIG. 6C with the diagram of FIG. 6A, the basic difference is to be seen in the fact that video cell 35Q is located at the beginning of the second target storage space 72 of the target disc 2T, so that the second target data portion 78 ranges from logical address Nt+1 to logical address Nt+X. The value of A is set to zero.

An advantage of this approach is that the size of the third remainder portion 76 has increased, which is available for possible further recordings. In this case, the target disc 2T does not have the second dummy data portion 75.

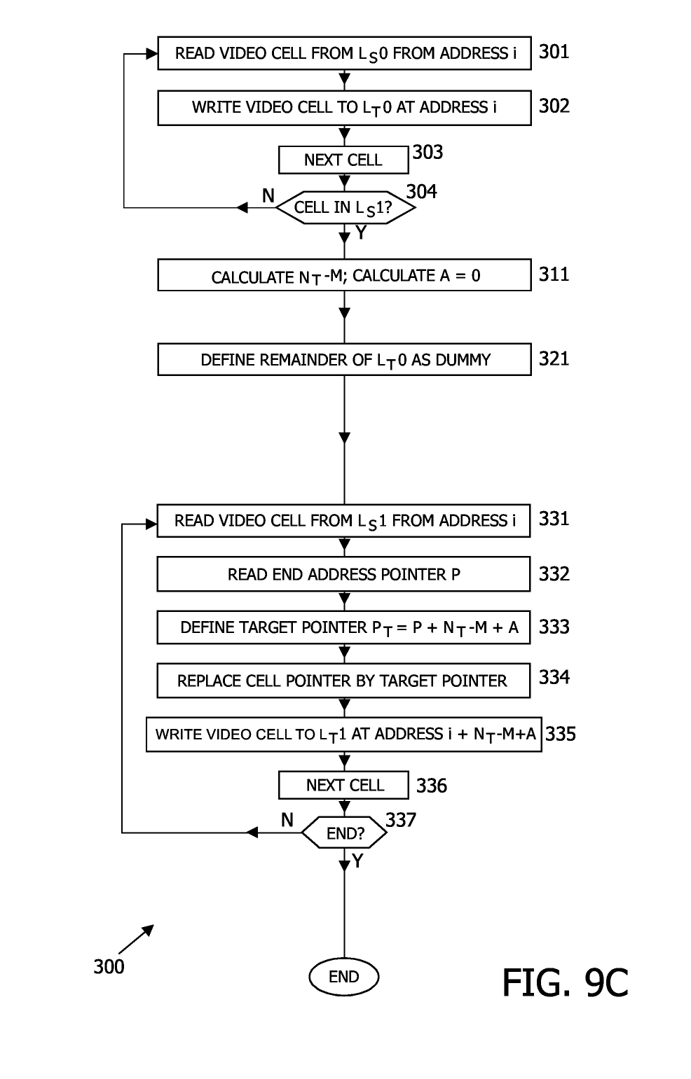

According to a further elaboration of the present invention, it is possible to further increase the efficiency in the use of storage space by recording the data from the second source data portion 68, at least partly, into the first target storage space 71, behind the first target data portion 77. Thus, after having written the first target data portion 77, the host 20 continues with reading the data of the second source data portion 68 of the source disc 2S, and sends this data to the disc drive 10, which will write this data in the first target storage space 71, starting at the first address available after the first target data portion 77, i.e. starting at physical address M+1, such that cell 35Q is adjacent to cell 35P. This phase of the recording process according to the present invention is illustrated in FIG. 7A. This phase continues until a certain physical address M+Y, when the next cell 35R of the second source data portion 68 does not fit any more in the first target storage space 71.

When this phase has been completed, the first target storage space 71 of the target disc 2T contains a second target data portion 81, copy of a first part of the second source data portion 68, extending from physical address M+1 to physical address M+Y. The portion of the first target storage space 71 beyond this address, i.e. from physical address M+Y+1 to physical address Nt, will be indicated as first remainder portion 84.

According to an aspect of the present invention, this first remainder portion 84 of the target disc 2T is defined as a dummy data portion, indicated by the hatching in FIG. 7B. For this first remainder portion 84, the same applies as for the first remainder portion 74 discussed with reference to FIG. 5C.

Now that the host 20 has entirely written the first target storage space 71, a transition can be made to the second target storage space 72, and the remainder part of the second source data portion 68 of the source disc 2S can be copied. The present invention provides three different variations, which are comparable to the variations explained with reference to FIGS. 6A-C, so the explanation will not be repeated extensively here.

In a first variation, illustrated in FIG. 7C, and comparable to the variation of FIG. 6A, a first portion 85 of the second target storage space 72 is defined as a dummy portion, and then recording of the remainder part of the second source data portion 68 is resumed, such that the beginning of the next cell 35R is substantially aligned with the end of the second target data portion 81. When this phase has been completed, the second target storage space 72 of the target disc 2T contains a third target data portion 82, copy of a second part of the second source data portion 68, extending from physical address Nt+1+(Nt−M−Y) to physical address M+X+2(Nt−M−Y).

In a second variation, not illustrated, comparable to the variation of FIG. 6B, the size of the first dummy portion 85 of the second target storage space 72 is increased such that the end of the third target data portion 82 is substantially aligned with the beginning of the first target data portion 77.

In a third variation, illustrated in FIG. 7D, and comparable to the variation of FIG. 6C, the first dummy portion 85 of the second target storage space 72 is omitted and recording of the remainder part of the second source data portion 68 is started from the first physical address Nt+1 in the second target storage space 72 of the target disc 2T.

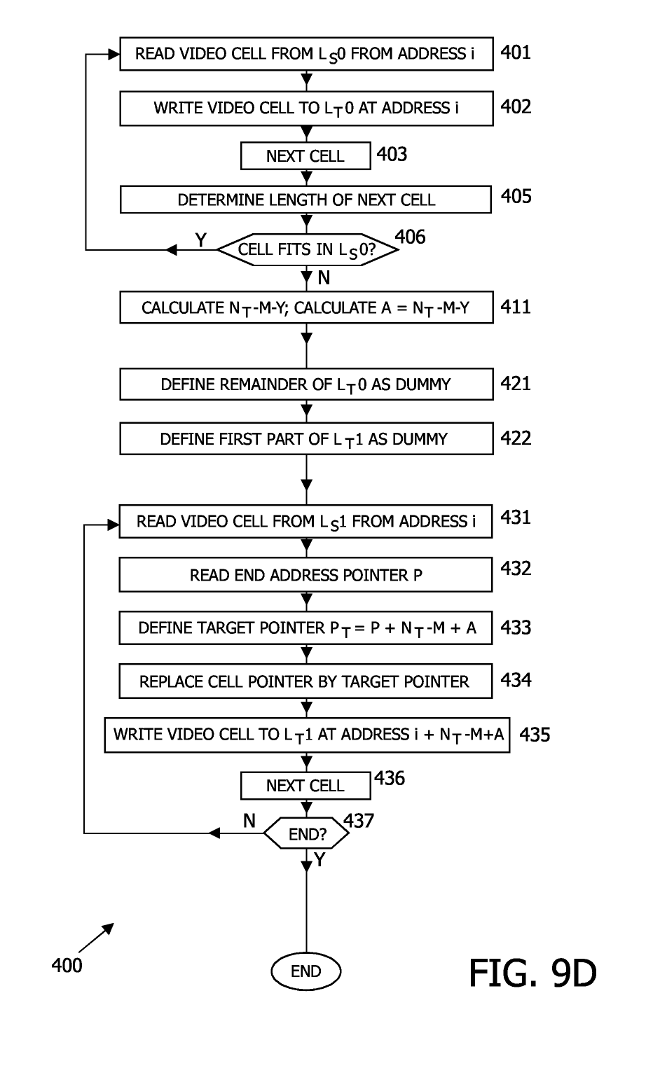

According to a further elaboration of the present invention, it is possible to even further increase the efficiency in the use of storage space by using the entire first target storage space 71. FIG. 8A is a diagram comparable to FIG. 7A, illustrating that recording of the second target data portion 81 in the first target storage space 71 has continued until the logical end address M+Y of a certain cell 35N, while the next cell 35R does not fit into the remainder part 84 of the first target storage space 71. Instead of defining this remainder part 84 as a dummy part, the data of the next cell 35R is split up into a first cell part 35R1 and a second cell part 35R2, such that the first cell part 35R1 fits exactly into the remainder part 84 of the first target storage space 71.

In the embodiment illustrated in FIG. 8B, the first cell part 35R1 is recorded in the first target storage space 71 behind the said certain cell 35N, from physical address M+Y+1 to physical address Nt, and the second cell part 35R2 is recorded in the second target storage space 72 starting from physical address Nt+1. After that, recording proceeds with the data of the next cell 35S.

It is noted that the process of taking data from a video cell and recoding this data to define a new cell is a process known per se to persons skilled in this art, so it is not necessary here to explain this process in great detail. It is noted that, in this embodiment, logical addresses are equal to physical addresses. It is further noted that, in this embodiment, the end address of the first cell part 35R1 is equal to Nt, and that the length of the first cell part 35R1 is smaller than the length of the original cell 35R, so the NAVPACK information in the first cell part 35R1 relating to cell length and cell end address must be adapted. It is further noted that, in this embodiment, the end address of the second cell part 35R2 remains the same but the length of the second cell part 35R2 is smaller than the length of the original cell 35R, so the NAVPACK information in the second cell part 35R2 relating to cell length must be adapted.

As a result of splitting the cell 35R into two new cells, one cell boundary is added at the transition from the first target storage space 71 to the second target storage space 72. If this cell boundary is not added, seamless display can not be assured when the recording 73 is played.

It may, however, be undesirable to increase the total number of cell boundaries. FIG. 8C illustrates a variation which differs from the embodiment illustrated in FIG. 8B in that the data of the said certain cell 35N and of the first cell part 35R1 are combined to define a single new cell 35RX. It is noted that the process of taking data from two video cells and recoding this data to define a new cell is a process known per se to persons skilled in this art, so it is not necessary here to explain this process in great detail. It is noted that the end address of the new combined cell 35X is equal to Nt, and that the length of the new combined cell 35X typically differs from the lengths of the original cells 35N and 35R1, so the NAVPACK information in the new combined cell 35X relating to cell length and cell end address must be adapted.

FIG. 8D illustrates a variation which differs from the embodiment illustrated in FIG. 8B in that the data of the next cell 35S and of the second cell part 35R2 are combined to define a single new cell 35RY. It is noted that the end address of the new combined cell 35X is equal to the original end address of cell 35S, and that the length of the new combined cell 35X typically differs from the lengths of the original cells 35N and 35R2, so the NAVPACK information in the new combined cell 35Y relating to cell length and cell end address must be adapted.

A combination of the embodiments of FIGS. 8C and 8D is also possible, such that both combined cells 35RX and 35RY result: in such case, the number of cell boundaries is even reduced by one.

In the embodiments of FIG. 8C or 8D, the new combined cell 35RX or 35RY have a length larger than the original length of original cell 35N or 35S. If it is considered that the increase in cell length should be minimized, the host may select one of the embodiments of FIG. 8C or 8D depending on which half 35R1 or 35R2 of cell 35R is shortest.

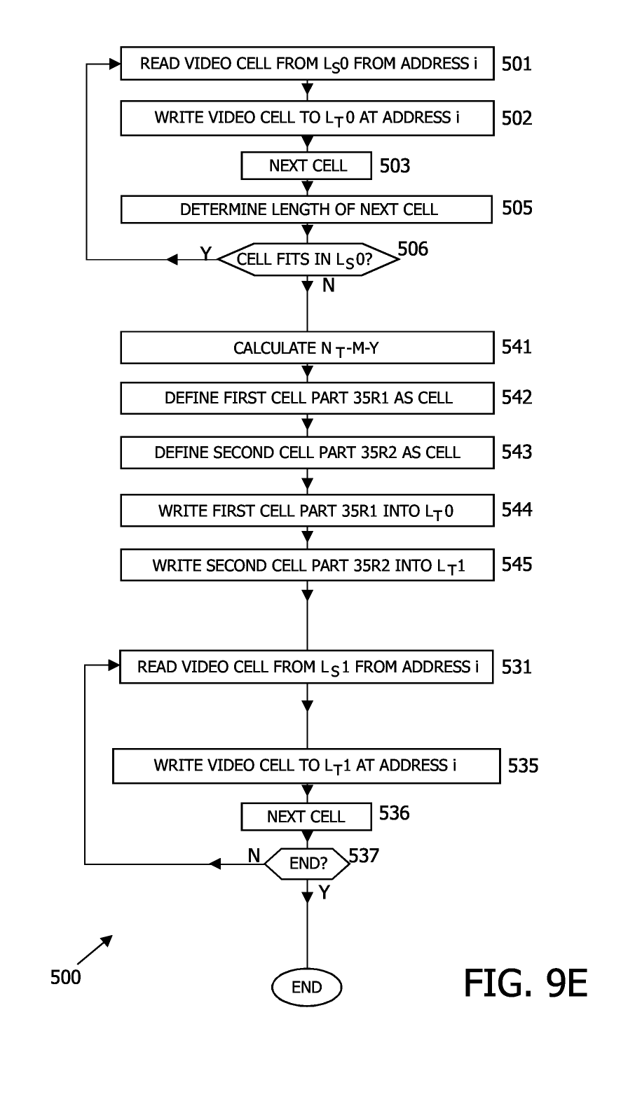

FIG. 9A is a flow diagram illustrating the steps of an exemplary copying method 100 performed by the data storage system implemented in accordance to the present invention as explained with reference to FIG. 6A.

When receiving a copy command for recording 63, the host 20 is designed to first copy the first source data portion 67 to the first target storage space Lt0 [steps 101-104]. The host starts reading a video cell from the first source storage space Ls0 of the source disc 2S, starting from logical source address i [step 101], and writes this video cell to the first target storage space Lt0 of the target disc 2T, starting from logical target address i [step 102]. When the host 20 is associated with two disc drives, one source disc drive for reading the source disc and one target disc drive for writing the target disc, the host may send the video data to be written to the target disc drive as soon as it receives the video data from the source disc drive. However, it is also possible that the host receives video data of an entire video cell and stores this video data in a buffer memory, and sends data from this buffer memory to the target disc drive only after having received an entire video cell. It is also possible that the host is associated with one disc drive only, so that this disc drive is first used for reading the entire source disc, after which the source disc is replaced by the target disc and the disc drive is used for writing the target disc; in that case, the host may first store the entire recording 63 on its hard disc and use the information from its hard disc when writing the target disc.

In step 103, the host continues to the next cell. In step 104, the host checks whether this next cell is located in the second source storage space Ls1 of the source disc. If not, then the host jumps back to step 101 and the above process is repeated.

If the host finds that the next cell is located in the second source storage space Ls1 of the source disc 2S, the host calculates the size Nt−M of the remaining portion 74 of the first target storage space Lt0, and calculates the size A for the initial dummy portion 75 in the second target storage space Lt1 [step 111]; in this case, this size A is equal to the size Nt−M of the remaining portion 74 of the first target storage space Lt0.

In a next phase, the host defines the remaining portion 74 of the first target storage space Lt0 as a dummy portion, by writing dummy data into this storage space portion 74, i.e. from physical address M+1 to physical address Nt [step 121].

In a next phase, the host defines the initial dummy portion 75 in the second target storage space Lt1 as a dummy portion, by writing dummy data into this storage space portion 75, i.e. from physical address Nt+1 to physical address 2Nt−M [step 122].

In a next phase, the copying process continues. In step 131, the host reads a video cell from the second source storage space Ls1 of the source disc, starting from logical source address i. Before recording this cell, the cell is recoded. In step 132, the host reads the pointer information P indicating the logical end address of the current video cell, and in step 133 the host calculates a new value for this pointer, indicated as target pointer PT, by increasing the source pointer P by N_{T}−M+A. In step 134, the host replaces the source pointer P by the target pointer PT. In step 135, the host writes the current video cell with the replaced target pointer PT to the second target storage space Lt1 of the target disc, starting from logical address i+N_{T}−M+A.

Then, the host proceeds to the next video cell of the source recording 63 [step 136]. If the end of the recording has not yet been reached [step 137], the host returns to step 131 and the above process is repeated.

FIG. 9B is a flow diagram illustrating the steps of an exemplary copying method 200 performed by the data storage system implemented in accordance to the present invention as explained with reference to FIG. 6B. Reference numerals indicating steps which are equal or equivalent to steps of method 100 are the same as the corresponding reference numerals in FIG. 9A, yet increased by 100. Basically, the difference between method 200 and method 100 comes to expression in step 211, where A is now calculated as A=N_{T}−X+1.

FIG. 9C is a flow diagram illustrating the steps of an exemplary copying method 300 performed by the data storage system implemented in accordance to the present invention as explained with reference to FIG. 6C. Reference numerals indicating steps which are equal or equivalent to steps of method 100 are the same as the corresponding reference numerals in FIG. 9A, yet increased by 200. Basically, the difference between method 300 and method 100 comes to expression in step 311, where A is now calculated as A=0, while further the step 122, defining an initial dummy portion in the second target storage space Lt1, is omitted.

FIG. 9D is a flow diagram illustrating the steps of an exemplary copying method 400 performed by the data storage system implemented in accordance to the present invention as explained with reference to FIG. 7C. Reference numerals indicating steps which are equal or equivalent to steps of method 100 are the same as the corresponding reference numerals in FIG. 9A, yet increased by 300. Basically, the difference between method 400 and method 100 comes to expression in steps 405 and 406 and 411. The fact whether or not a source cell is located in the second source storage space Ls1 (step 104) does not play a role any more: in the first copying phase, the host, when accessing a next source cell [step 403], determines the length of this next cell [step 405], and checks whether this next cell fits into the remainder of the first target logical space Lt0 [step 406]. If the next cell does fit, the host jumps back to step 401 and the copying process continues. If the next cell does not fit, the host continues to step 411, where A is now calculated as A=Nt−M−Y.

Similar to method 200 of FIG. 9B, if it is desired that the end of the recording portion 82 in the second logical space Lt1 is aligned with the beginning of the recording portion 77 in the first logical space Lt0, the value of A is calculated accordingly; this adaptation is not illustrated in a separate flow diagram.

Similar to method 300 of FIG. 9C, if it is desired that the beginning of the recording portion 82 in the second logical space Lt1 is aligned with the beginning of the second logical space Lt1 (see FIG. 7D), the value of A is set to zero and step 422, defining an initial dummy portion in the second target storage space Lt1, is omitted; this adaptation is not illustrated in a separate flow diagram.

FIG. 9E is a flow diagram illustrating the steps of an exemplary copying method 500 performed by the data storage system implemented in accordance to the present invention as explained with reference to FIG. 8B. Reference numerals indicating steps which are equal or equivalent to steps of method 400 are the same as the corresponding reference numerals in FIG. 9D, yet increased by 100. Basically, the difference between method 400 and method 500 comes to expression in steps 541 to 545, where the next cell 35R is split into two cell parts and recorded into Lt0 and Lt1, respectively. In step 541, the host calculates the size Nt−M−Y of the remaining portion 84 of the first target storage space Lt0. In step 542, the host takes the first part 35R1 of the next cell 35R, involving an amount of data corresponding to the calculated size Nt−M−Y, and defines this first cell part 35R1 as a cell. In step 543, the host takes the remaining part 35R2 of the next cell 35R, and defines this second cell part 35R2 as a cell. In step 543, the host sends the data of the first cell part 35R1 to the disc drive 10, which stores this cell in the remaining portion 84 of the first target storage space Lt0. In step 544, the host sends the data of the second cell part 35R2 to the disc drive 10, which stores this cell in the beginning of the second target storage space Lt1. It is noted that the order of steps 543 and 544 may be inversed.

Then, the host continues with the remaining cells from the source recording 63 [steps 531-537]. It is noted that the address pointer information in the cells does not need to be changed, so steps 432-434 are omitted.

With reference to FIG. 8C, if it is desired that the first cell part 35R1 is combined with the previous cell 35N, step 542 is replaced by the steps of taking the first part 35R1 of the next cell 35R, involving an amount of data corresponding to the calculated size Nt−M-Y; taking the data from the previous cell 35N; combining these data to define a first combined cell 35RX; and step 544 is replaced by the step of sending the data of the first combined cell 35RX to the disc drive 10; this adaptation is not illustrated in a separate flow diagram.

It is noted that, in order to facilitate these steps, the host may comprise a buffer memory 23 where the previous cell 35N is stored for possible combination with part of the next cell.

With reference to FIG. 8D, if it is desired that the second cell part 35R2 is combined with the subsequent cell 35S, step 543 is replaced by the steps of taking the second part 35R2 of the next cell 35R; reading the subsequent cell 35S; combining these data to define a second combined cell 35RY; and step 545 is replaced by the step of sending the data of the second combined cell 35RY to the disc drive 10; this adaptation is not illustrated in a separate flow diagram.

In the above, it has been assumed that the source data is available on a source medium in the form of a multi-layered optical disc, while part of the source data is located in a first layer and part of the source data is located in a next layer. The present invention can, however, also be implemented in case the source data is available in one contiguous storage space, without being divided over two (or more) storage spaces. An example of such situation is for instance the case where the source data is located on a source medium having a capacity larger than the storage capacity of the DVD-RW disc; an example of such source medium is a hard disc.

Another example of such situation is for instance the case where the source data is located on a single-layer optical disc, while a first portion of the first storage space Lt0 of the target dual-layer disc has already been used for storing data, such that the copying process can not start recording the copy data from the first address in the first target storage space Lt0.

In all of these examples, it may be that the available storage space in the first target storage space Lt0 is not enough for recording the entire copy recording, so a transition has to be made from the first target storage space Lt0 to the second target storage space. In any case, the host has at all times information available regarding the size of the remaining part of the first target storage space Lt0, and regarding the size of the cells to be copied. Thus, in all of these cases, the host can perform the method as described with reference to FIGS. 7A-D and 8A-D, with the exception (or simplification) that the transition from first source storage space Ls0 to second source storage space Ls1, at address M, is no longer present.

It is noted that the above example relates to the transition from the first storage space L0 to the second storage space L1. Similar considerations would play a roll when a disc has three or more storage layers, and a transition is to be made from the second storage space L1 to a third storage space L2, or from the third storage space L2 to a fourth storage space L3, etc.

It should be clear to a person skilled in the art that the present invention is not limited to the exemplary embodiments discussed above, but that several variations and modifications are possible within the protective scope of the invention as defined in the appending claims.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Method (FIGS. 6A-C) for recording information on a multi-layered optical target disc (2T), the target disc comprising at least a first target storage space (Lt0) and a second target storage space (Lt1) in adjacent storage layers (40, 41), each storage space comprising physical storage locations with physical storage addresses;
wherein, on recording, first the first target storage space (Lt0) is written until the last physical storage address (Nt) of the first target storage space (Lt0), and then the recording process makes a transition to the first physical storage address (Nt+1) of the second target storage space (Lt1);
wherein data to be recorded are copied from a source storage medium;
wherein the source storage medium is a multi-layered optical source disc (2S), the source disc comprising at least a first source storage space (Ls0) and a second source storage space (Ls1) in adjacent storage layers, each source storage space comprising storage locations with storage addresses;
wherein the data to be copied are organized in cells (35), each cell corresponding to a certain amount of data;
wherein a first portion (67) of the said source data cells is located in the first source storage space (Ls0) of the source disc (2S) and a second portion (68) of the said source data cells is located in the second source storage space (Ls1) of the source disc (2S);
wherein the said first source data portion (67) has a logical end address (M) smaller than the physical end address (Nt) of the first target storage space (Lt0) of the target disc (2T);
wherein the said second source data portion (68) has a logical start address (M+1) and a logical end address (M+X);
the recording method comprising the steps of reading all source cells from the first source storage space (Ls0) of the source disc (2S) and recording these cells into a first target data portion (77) of the first target storage space (Lt0) of the target disc (2T);
the recording method further comprising the step of defining the remainder portion (74) of the first target storage space (Lt0) of the target disc (2T) as a dummy data portion, and then writing the cells from the said second source data portion (68) into a second target data portion (78) of the second target storage space (Lt1) of the target disc (2T).

2. Method according to claim 1, wherein dummy data are written in the remainder portion (74) of the first target storage space (Lt0) of the target disc (2T) from the first physical address (M+1) after the last-recorded cell (35P) to the physical end address (Nt).

3. Method according to claim 1, wherein recording of the cells from the said second source data portion (68) is started from the first physical address (Nt+1) in the second target storage space (Lt1) of the target disc (2T), such that data read from a logical source address i is recorded at a logical target address i+(Nt−M).

4. Method according to claim 1, wherein a first portion (75) of the second target storage space (Lt1) of the target disc (2T) is defined as a second dummy data portion, from the first physical address (Nt+1) of the second target storage space (Lt1) to a physical second dummy portion end address (Nt+A);
and wherein recording of the cells from the said second source data portion (68) is started from the first physical address (Nt+A+1) after said physical second dummy portion end address (Nt+A).

5. Method according to claim 4, wherein A is substantially equal to Nt−M, such that the beginning of the first cell (35Q) in the second target data portion (78) is substantially aligned with the end of the last cell (35P) in the first target data portion (77).

6. Method according to claim 4, wherein A is substantially equal to Nt−X+1, such that the end of the second target data portion (78) is substantially aligned with the beginning of the first target data portion (77).

7. Method (FIGS. 7A-D) for recording information on a multi-layered optical target disc (2T), the target disc comprising at least a first target storage space (Lt0) and a second target storage space (Lt1) in adjacent storage layers (40, 41), each storage space comprising physical storage locations with physical storage addresses;
wherein, on recording, first the first target storage space (Lt0) is written until the last physical storage address (Nt) of the first target storage space (Lt0), and then the recording process makes a transition to the first physical storage address (Nt+1) of the second target storage space (Lt1);
wherein data to be recorded are copied from a source storage medium;
wherein the source storage medium is a multi-layered optical source disc (2S), the source disc comprising at least a first source storage space (Ls0) and a second source storage space (Ls1) in adjacent storage layers, each source storage space comprising storage locations with storage addresses;
wherein the data to be copied are organized in cells (35), each cell corresponding to a certain amount of data;
wherein a first portion (67) of the said source data cells is located in the first source storage space (Ls0) of the source disc (2S) and a second portion (68) of the said source data cells is located in the second source storage space (Ls1) of the source disc (2S);
wherein the said first source data portion (67) has a logical end address (M) smaller than the physical end address (Nt) of the first target storage space (Lt0) of the target disc (2T);
wherein the said second source data portion (68) has a logical start address (M+1) and a logical end address (M+X);
the recording method comprising the steps of reading all source cells from the first source storage space (Ls0) of the source disc (2S) and recording these cells into a first target data portion (77) of the first target storage space (Lt0) of the target disc (2T);
the recording method further comprising the steps of:
reading source cells from the second source data portion (68) and recording these cells into a second target data portion (81) of the first target storage space (Lt0) of the target disc (2T);
defining the remainder portion (84) of the first target storage space (Lt0) of the target disc (2T) as a dummy data portion, and then
writing the cells from the remainder part of said second source data portion (68) into a third target data portion (82) of the second target storage space (Lt1) of the target disc (2T).

8. Method according to claim 7, wherein dummy data are written in the remainder portion (84) of the first target storage space (Lt0) of the target disc (2T) from the first physical address (M+Y+1) after the last-recorded cell (35N) to the physical end address (Nt).

9. Method according to claim 7, wherein recording of the cells from the said remainder part of said second source data portion (68) is started from the first physical address (Nt+1) in the second target storage space (Lt1) of the target disc (2T).

10. Method according to claim 7, wherein a first portion (85) of the second target storage space (Lt1) of the target disc (2T) is defined as a second dummy data portion, from the first physical address (Nt+1) of the second target storage space (Lt1) to a physical second dummy portion end address (Nt+A);
and wherein recording of the cells from the said remainder part of said second source data portion (68) is started from the first physical address (Nt+A+1) after said physical second dummy portion end address (Nt+A).

11. Method according to claim 10, wherein the size of the said second dummy data portion (85) is substantially equal to the size of the said first dummy data portion (84), such that the beginning of the first cell (35R) in the third target data portion (82) is substantially aligned with the end of the last cell (35N) in the second target data portion (81).

12. Method according to claim 10, wherein the size of the said second dummy data portion (85) is chosen such that the end of the third target data portion (82) is substantially aligned with the beginning of the first target data portion (77).

13. Method according to claim 7, wherein the step of reading source cells from the second source data portion (68) and recording these cells into the second target data portion (81) is continued until reaching a cell (35R) having a size larger than the capacity of the remainder portion (84) of the first target storage space (Lt0).

14. Method (FIGS. 8A-D) for recording information on a multi-layered optical target disc (2T), the target disc comprising at least a first target storage space (Lt0) and a second target storage space (Lt1) in adjacent storage layers (40, 41), each storage space comprising physical storage locations with physical storage addresses;
wherein, on recording, first the first target storage space (Lt0) is written until the last physical storage address (Nt) of the first target storage space (Lt0), and then the recording process makes a transition to the first physical storage address (Nt+1) of the second target storage space (Lt1);
wherein data to be recorded are copied from a source storage medium;
wherein the source storage medium is a multi-layered optical source disc (2S), the source disc comprising at least a first source storage space (Ls0) and a second source storage space (Ls1) in adjacent storage layers, each source storage space comprising storage locations with storage addresses;
wherein the data to be copied are organized in cells (35), each cell corresponding to a certain amount of data;
wherein a first portion (67) of the said source data cells is located in the first source storage space (Ls0) of the source disc (2S) and a second portion (68) of the said source data cells is located in the second source storage space (Ls1) of the source disc (2S);
wherein the said first source data portion (67) has a logical end address (M) smaller than the physical end address (Nt) of the first target storage space (Lt0) of the target disc (2T);
wherein the said second source data portion (68) has a logical start address (M+1) and a logical end address (M+X);
the recording method comprising the steps of reading all source cells from the first source storage space (Ls0) of the source disc (2S) and recording these cells into a first target data portion (77) of the first target storage space (Lt0) of the target disc (2T);
the recording method further comprising the steps of:
reading source cells from the second source data portion (68) and recording these cells into a second target data portion (81) of the first target storage space (Lt0) of the target disc (2T), until reaching a next cell (35R) having a size larger than the capacity of the remainder portion (84) of the first target storage space (Lt0);
splitting up the contents of said next cell (35R) into a first cell part (35R1) and a second cell part (35R2), wherein the length of the first cell part (35R1) is set to be equal to the capacity of the remainder portion (84) of the first target storage space (Lt0);
recording the first cell part (35R1) into the first target storage space (Lt0);
recording the second cell part (35R2) into the second target storage space (Lt1), starting from the first physical address (Nt+1) in the second target storage space (Lt1); and then
writing the cells from the remainder part of said second source data portion (68) into a third target data portion (82) of the second target storage space (Lt1) of the target disc (2T).

15. Method according to claim 14, wherein the data of the first cell part (35R1) are defined as one cell, and wherein the data of the second cell part (35R2) are defined as one cell.

16. Method according to claim 14, wherein the data of the first cell part (35R1) are combined with the data of the previous cell (35N), and wherein the combined data are defined as one cell (35RX).

17. Method according to claim 14, wherein the data of the second cell part (35R2) are combined with the data of the subsequent cell (35S), and wherein the combined data are defined as one cell (35RY).

18. Method (FIGS. 7A-D) for recording information on a multi-layered optical target disc (2T), the target disc comprising at least a first target storage space (Lt0) and a second target storage space (Lt1) in adjacent storage layers (40, 41), each storage space comprising physical storage locations with physical storage addresses;
wherein, on recording, first the first target storage space (Lt0) is written until the last physical storage address (Nt) of the first target storage space (Lt0), and then the recording process makes a transition to the first physical storage address (Nt+1) of the second target storage space (Lt1);
wherein data to be recorded are copied from a source storage medium;
wherein the source storage medium is a single-space medium such as for instance a hard disc;
wherein the data to be copied are organized in cells (35), each cell corresponding to a certain amount of data;
the recording method comprising the steps of:
reading source cells from the source storage medium and recording these cells into the first target storage space (Lt0) of the target disc (2T), until reaching a next cell (35R) having a size larger than the capacity of the remainder portion (84) of the first target storage space (Lt0);
defining the remainder portion (84) of the first target storage space (Lt0) of the target disc (2T) as a dummy data portion, and then
writing the remainder source cells into the second target storage space (Lt1) of the target disc (2T).

19. Method according to claim 18, wherein dummy data are written in the remainder portion (84) of the first target storage space (Lt0) of the target disc (2T) from the first physical address after the last-recorded cell (35N) to the physical end address (Nt).

20. Method according to claim 18, wherein recording of the remainder source cells is started from the first physical address (Nt+1) in the second target storage space (Lt1) of the target disc (2T).

21. Method according to claim 18, wherein a first portion (85) of the second target storage space (Lt1) of the target disc (2T) is defined as a second dummy data portion, from the first physical address (Nt+1) of the second target storage space (Lt1) to a physical second dummy portion end address (Nt+A);
and wherein recording of the remainder source cells is started from the first physical address (Nt+A+1) after said physical second dummy portion end address (Nt+A).

22. Method according to claim 21, wherein the size of the said second dummy data portion (85) is substantially equal to the size of the said first dummy data portion (84), such that the beginning of the first cell (35R) in the second target storage space (Lt1) is substantially aligned with the end of the last cell (35N) in the first target storage space (Lt0).

23. Method (FIGS. 8A-D) for recording information on a multi-layered optical target disc (2T), the target disc comprising at least a first target storage space (Lt0) and a second target storage space (Lt1) in adjacent storage layers (40, 41), each storage space comprising physical storage locations with physical storage addresses;
wherein, on recording, first the first target storage space (Lt0) is written until the last physical storage address (Nt) of the first target storage space (Lt0), and then the recording process makes a transition to the first physical storage address (Nt+1) of the second target storage space (Lt1);
wherein data to be recorded are copied from a source storage medium;
wherein the source storage medium is a single-space medium such as for instance a hard disc;
wherein the data to be copied are organized in cells (35), each cell corresponding to a certain amount of data;
the recording method comprising the steps of:
reading source cells from the source storage medium and recording these cells into the first target storage space (Lt0) of the target disc (2T), until reaching a next cell (35R) having a size larger than the capacity of the remainder portion (84) of the first target storage space (Lt0);
splitting up the contents of said next cell (35R) into a first cell part (35R1) and a second cell part (35R2), wherein the length of the first cell part (35R1) is set to be equal to the capacity of the remainder portion (84) of the first target storage space (Lt0);
recording the first cell part (35R1) into the first target storage space (Lt0);
recording the second cell part (35R2) into the second target storage space (Lt1), starting from the first physical address (Nt+1) in the second target storage space (Lt1); and then
writing the remainder source cells into the second target storage space (Lt1) of the target disc (2T).

24. Method according to claim 23, wherein the data of the first cell part (35R1) are defined as one cell, and wherein the data of the second cell part (35R2) are defined as one cell.

25. Method according to claim 23, wherein the data of the first cell part (35R1) are combined with the data of the previous cell (35N), and wherein the combined data are defined as one cell (35RX).

26. Method according to claim 23, wherein the data of the second cell part (35R2) are combined with the data of the subsequent cell (35S), and wherein the combined data are defined as one cell (35RY).

27. Host apparatus (20), designed for executing the method of claim 1.

28. Multi-layered DVD-RW disc (2T) comprising at least a first storage space (Lt0) and a second storage space (Lt1) in adjacent storage layers (40, 41), the disc containing a recording (73), the data of which are grouped as cells, of which recording a first recording portion (77; 77, 81) is located in the first storage space (Lt0) while a subsequent second recording portion (78; 82) is located in the second storage space (Lt1);
wherein the first recording portion (77; 77, 81) has a logical end address (M; M+Y) smaller than the physical end address (Nt) of the first storage space (Lt0);
and wherein a remainder portion (74; 84) of the first storage space (Lt0), from the end of the first recording portion (77; 77, 81) to the end of the first storage space (Lt0), is defined as a dummy data portion.

29. Disc according to claim 28, wherein the said remainder portion (74; 84) contains dummy data.

30. Disc according to claim 28, wherein the second recording portion (78; 82) has its beginning aligned with the beginning of the second storage space (Lt1).

31. Disc according to claim 28, wherein the second recording portion (78; 82) has its beginning substantially aligned with the end of the first recording portion (77; 77, 81).

32. Disc according to claim 28, wherein the second recording portion (78; 82) has its end substantially aligned with the beginning of the first recording portion (77).

33. Disc according to claim 28, wherein the size of the remainder portion (74) of the first storage space (Lt0) is larger than the size of a cell (35).

34. Disc according to claim 28, wherein the size of the remainder portion (84) of the first storage space (Lt0) is smaller than the size of the first cell (35R) of the second recording portion (82).

35. Multi-layered DVD-RW disc (2T) comprising at least a first storage space (Lt0) and a second storage space (Lt1) in adjacent storage layers (40, 41), the disc containing a recording (73), the data of which are grouped as cells, of which recording a first recording portion (77, 81) is located in the first storage space (Lt0) while a subsequent second recording portion (82) is located in the second storage space (Lt1);
wherein the last cell (35R1; 35Rx) in the first recording portion (77, 81) has a logical end address corresponding to the physical end address (Nt) of the first storage space (Lt0).
